(19) United States
(12) Patent Application Publication
(10) Pub. No.: US 2026/0359783 A1
(43) Pub. Date: Nov. 12, 2026

(54) 3D LOGISTICS INTEGRATED MANAGEMENT SYSTEM

(71) Applicants: HYUNDAI MOTOR COMPANY, Seoul (KR); KIA CORPORATION, Seoul (KR)

(72) Inventors: Wonseok Choi, Seongnam-si (KR); Sunjoo Moon, Suwon-si (KR); Hyejun Park, Seoul (KR)

(73) Assignees: HYUNDAI MOTOR COMPANY, Seoul (KR); KIA CORPORATION, Seoul (KR)

(21) Appl. No.: 19/475,353

(22) PCT Filed: Sep. 27, 2023
(86) PCT No.: PCT/KR2023/095058

§ 371 Date: Oct. 14, 2025

(30) Foreign Application Priority Data
Apr. 14, 2023 (KR) 10-2023-0049215
Jun. 29, 2023 (KR) 10-2023-0084226

(51) Int. Cl. G06Q 10/087; G06F 3/04815; G06F 3/0482; G06Q 10/0631

(52) U.S. Cl. CPC G06Q 10/08741; G06F 3/04815; G06F 3/0482; G06Q 10/06316

(57) ABSTRACT

A 3D logistics integrated management system may include a server that stores information necessary for logistics management within a logistics center in a database, and collects and provides information from the database; an administrator terminal that displays data provided from the server as a 3D screen via a plurality of interfaces; and a worker terminal that displays data provided from the server as a 3D screen via a worker application. The server may collect and process relevant data among the stored data in response to a request from the administrator terminal and/or the worker terminal, and may transmit it to the administrator terminal and/or the worker terminal, and the 3D screen of each of the administrator terminal and the worker terminal may display a 3D model implemented by 3D modeling the logistics center, and the 3D modeling for the logistics center may be based on WebGL.

### TECHNICAL FIELD

The present disclosure relates to a 3D logistics integrated management system.

### BACKGROUND ART

Existing Warehouse Management System (WMS) systems are outdated, and intuitive data visibility through these WMS systems is difficult. Currently, there is no system capable of efficiently providing logistics management in line with the recent trend of fast delivery, such as same-day delivery and early morning delivery. Due to communication problems between administrators and workers using WMS systems, inventory omissions and theft incidents are occurring.

### DISCLOSURE

### Technical Problem

The present disclosure attempts to provide a system (hereinafter, “3D logistics integrated management system”) that implements a 3D integrated logistics management platform capable of managing a logistics center in real time anytime and anywhere.

The 3D logistics integrated management system according to the present disclosure attempts to provide real-time inventory monitoring, real-time equipment monitoring, and simulation functions in a 3D virtual logistics center.

The 3D logistics integrated management system according to the present disclosure attempts to provide a system that enables real-time bidirectional communication between workers and administrators.

### Technical Solution

A 3D logistics integrated management system may include a server that stores information necessary for logistics management within a logistics center in a database, and collects and provides information from the database; an administrator terminal that displays data provided from the server as a 3D screen via a plurality of interfaces; and a worker terminal that displays data provided from the server as a 3D screen via a worker application. The server may collect and process relevant data among the stored data in response to a request from the administrator terminal and/or the worker terminal, and may transmit it to the administrator terminal and/or the worker terminal, and the 3D screen of each of the administrator terminal and the worker terminal may display a 3D model implemented by 3D modeling the logistics center, and the 3D modeling for the logistics center may be based on WebGL.

### Advantageous Effects

The present disclosure may provide a system that may manage a logistics center in real-time anytime and anywhere. The 3D logistics integrated management system of the present disclosure may provide real-time inventory monitoring, real-time equipment monitoring, and simulation functions in a 3D virtual logistics center. The 3D logistics integrated management system of the present disclosure enables real-time two-way communication between workers and administrators.

### DESCRIPTION OF THE DRAWINGS

FIG. 1 is a drawing illustrating the configuration of a 3D integrated logistics management system according to an embodiment.

FIG. 2 is a block diagram illustrating the configuration of a logistics integrated management system according to an embodiment.

FIG. 3 is a drawing illustrating a 3D screen provided during operation of a virtual management system driven on the web according to an embodiment.

FIG. 4 is a drawing showing inventory search results through Web VMS.

FIG. 5 is a drawing showing status monitoring results through Web VMS.

FIG. 6 is a drawing showing an item tooltip provided through Web VMS.

FIG. 7 is a drawing showing item inquiry provided through Web VMS.

FIG. 8 is a drawing showing item registration provided through Web VMS.

FIG. 9 is a drawing showing equipment monitoring provided through Web VMS.

FIG. 10 is a drawing showing CCTV monitoring provided through Web VMS.

FIG. 11 is a drawing showing a CCTV image.

FIG. 12 is a drawing showing a message list and a message sending window displayed by Web VMS via an administrator terminal.

FIG. 13 is a drawing showing a task registration window and a task assignment window displayed by Web VMS via an administrator terminal.

FIG. 14 is a drawing showing a personnel management window displayed by Web VMS via an administrator terminal.

FIG. 15 is a drawing showing an asset management window displayed by Web VMS via an administrator terminal.

FIG. 16 is a drawing showing a logistics center management window displayed by Web VMS via an administrator terminal.

FIG. 17 is a drawing showing a 3D screen provided on a worker terminal.

FIG. 18 is a drawing showing a screen provided on a worker terminal for the worker's task progression.

FIG. 19 is a drawing showing a receiving task progress screen provided on a worker terminal.

FIG. 20 is a drawing showing a shipping task progress screen provided on a work terminal.

FIG. 21 is a drawing showing a status management screen provided on an administrator terminal.

FIG. 22 is a drawing showing a warehouse management screen provided on an administrator terminal.

### MODE FOR INVENTION

Some embodiments of the present disclosure may provide a 3D logistics integrated management system that operates based on WebGL. The 3D logistics integrated management system may operate on the Web without a separate installation file, thereby enabling logistics integrated management to be provided in a 3D environment. Some embodiments may be a 3D logistics integrated management system utilizing an Infrastructure as a Service (IaaS) cloud. In the 3D logistics integrated management system according to some embodiments, various IoT devices within a logistics center may provide real-time monitoring of the inside of the logistics center by communicating real-time data status with an IoT server. The 3D logistics integrated management system according to some embodiments may inquire about and update the locations of workers and equipment within the logistics center using QR code scanning via a smartphone camera, and may provide product information inquiry. The 3D logistics integrated management system according to some embodiments may encrypt QR encryption codes to block access to encrypted information when unauthorized QR scanning occurs. The 3D logistics integrated management system according to some embodiments may stream CCTV streaming images in real time, provide work status via smartphone push notifications, and perform location tracking using smartphone GPS. The 3D logistics integrated management system according to some embodiments may use Windows, Mac, Linux, or the like as an operating system. In this case, the operating system of a terminal device, such as a smartphone, PDA, or tablet, may be iOS, Android, or the like.

In the following description, the terms “goods” and “products” may be understood to refer to various items such as those received into a logistics center, stored after receipt, or dispatched during storage.

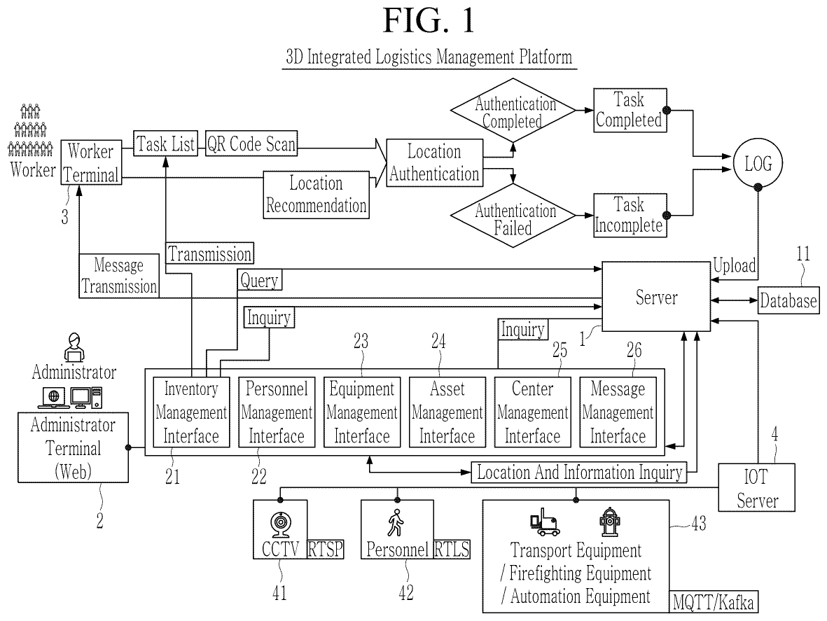

FIG. 1 is a drawing illustrating the configuration of a 3D integrated logistics management system according to an embodiment.

A server 1 may collect, process, and store various information necessary for logistics management within a logistics center, and the server 1 may collect and process relevant data from the stored data in response to requests such as searching and querying from an administrator terminal 2 and/or a worker terminal 3, generate logistics data, and transmit the generated logistics data to the administrator terminal 2 and/or the worker terminal 3. The various information necessary for logistics management may include information about items within the logistics center. A worker may be equipped with a worker terminal 3 such as a smartphone, a PDA, or a tablet. An administrator may issue commands necessary for integrated management and query necessary information through an administrator terminal 2, such as an administrator terminal connected to the web. The administrator terminal 2 is not limited to an administrator terminal and may be a smartphone, a PDA, a tablet, or the like. A wireless network is established between the server 1, the administrator terminal 2, and the worker terminal 3, so that they enable data transmission and reception via the wireless network. The wireless network method is not limited.

The server 1 may include a cloud server, a streaming server, a Real-Time Location System (RTLS) server, and an IOT CORE. A database 10 may include a cloud storage, a Relational Database Service (RDS) DB, and a DYNAMO DB. In FIG. 1, the server 1 and the database 10 are illustrated as being separated, but the server 1 may include the database 10. The server 1 may store various information necessary for logistics center management in the database 10, collect required data from the database 10 upon request, and provide the collected data to a plurality of interfaces 21 to 26 and the worker terminal 3.

The administrator terminal 2 may display logistics data provided to the administrator terminal 2 from the server 1 and/or the worker terminal 3 via a plurality of interfaces provided from a Virtual Management System (VMS) on a 3D screen. The VMS may provide various interfaces necessary for item management in the logistics center. The VMS may be implemented on the server 1 or the administrator terminal 2.

Information related to logistics management, input through various interfaces provided by the VMS, may be transmitted to the server 1 and/or the worker terminal 3. A worker application is installed on the worker terminal 3, and the worker terminal 3 may display logistics data provided from the server 1 and/or the administrator terminal 2 via the worker application on a 3D screen. Information related to logistics management, input through the worker terminal 3, may be transmitted to the server 1 or the administrator terminal 2 via the worker application. The 3D screen displays a 3D model that implements the structure and interior of the logistics center by 3D modeling, and the 3D modeling for the logistics center may be based on WebGL.

The server 1 includes a database and may store work history, inventory lists, and the like in the database. An IOT server 4 may collect real-time audio/video data from CCTVs via RTSP through IOT and provide it to the server 1. The IOT server 4 may identify the location of personnel performing tasks using RTLS and provide it to the server 1. The IOT server 4 may continuously publish-write, subscribe-read, store, and process event streams with transportation equipment, automation equipment, and fire suppression systems via Message Queuing Telemetry Transport (MQTT) and Kafka.

An administrator may perform inventory management, personnel management, equipment management, asset management, center management, message management, and the like via the administrator terminal 2. The inventory management may include inventory search, status tracking of receipts/shipments and returns/inspections, and work list generation. The personnel management may include management of workers' commuting and work schedules. The equipment management may include management of transportation equipment, CCTV, automation equipment, firefighting equipment, and the like. The asset management may include management of sales, profit and loss, orders, and the like. The center management may include center relocation, center registration, and the like. The message management may include managing sending messages, message history, and the like.

For equipment management, the administrator may query information about the equipment's location and various equipment information provided to the server 1 from the IOT server 4, via the administrator terminal 2. The administrator may query relevant data from the server 1 to manage the status of inbound/outbound shipments and returns/inspections. To search for stored inventory, the administrator may transmit a query for the inventory to be searched to the server 1, and the server 1 may transmit information about the relevant inventory to the administrator terminal 2 in response to the query. The administrator may query necessary information from the server 1 for asset management. The administrator may generate a work list via the administrator terminal 2 and transmit it to the worker terminal 3. The work list may include information about items that are the subject of inbound, outbound, return, or inspection tasks to be performed by the worker. The information about the items may include information about the item name, item location, item quantity, and the like.

A worker may transmit and receive messages with the server 1 via the worker terminal 3. When a work list is received from the administrator terminal 2, a QR code recorded in the work list may be scanned, and the location to move to as a result of the scan may be received from the server 1 to the terminal 3. The server 1 may derive the location of the item closest to the worker's location among the items corresponding to the QR code received via the worker terminal 3, and recommend it as the location for the worker to move to. The worker may move to the location provided via the worker terminal 3 and authenticate arrival at the location received from the server 1 via the worker terminal 3 (location authentication). The worker may use the worker terminal 3 to read a QR code, barcode, or the like attached to the rack where the item is located, and transmit the read information to the server 1. The server 1 may perform location authentication by comparing the location based on the received read information with the location transmitted to the worker terminal 3. If location authentication is completed, the server 1 may generate and upload a LOG record of the task completion. If location authentication fails, the server 1 may generate and upload a LOG record of work incompletion.

The server 1 generates work history and inventory lists and may update them according to new information. Information necessary for work history and inventory lists may be provided from the worker terminal 3, the IOT server 4, and the like. Message transmission and reception are provided between the server 1 and the worker terminal 3, allowing various information to be transmitted and received from the server 1 to the worker terminal 3 or from the worker terminal 3 to the server 1.

The administrator may perform various management tasks via the administrator terminal 2. Inventory management, personnel management, equipment management, asset management, center management, and message management may be provided through the administrator terminal 2.

The administrator terminal 2 may be provided with interfaces for inventory management, personnel management, equipment management, asset management, center management, and message management, respectively. For example, when an administrator selects buttons, icons, or the like representing inventory management, personnel management, equipment management, asset management, center management, and message management on a screen of the administrator terminal 2, an interface for performing the selected management task may be provided on the screen of the administrator terminal 2. According to the embodiment, an inventory management interface 21, a personnel management interface 22, an equipment management interface 23, an asset management interface 24, a center management interface 25, and a message management interface 26 may be provided to the administrator terminal 2 from the server 1 via the web, or may be built and operated on the administrator terminal 2. Each interface may recognize information input from the outside, request information to the outside, process the recognized information or information received in response to the request, and display the processing result to the outside. Each interface may include software, which is a set of commands for performing a set operation, and communication hardware that transmits information requests to the outside and receives information from the outside.

The inventory management interface 21 may provide functions for searching for items within a logistics center, inquiring about receiving/shipping and return/inspection status, and confirming work lists. The receiving/shipping and return/inspection status for items within the logistics center includes the status of items to be received and/or received into the logistics center, items to be shipped and/or shipped from the logistics center, items to be returned and/or returned to the logistics center, and items to be inspected and/or inspected at the logistics center. The inventory management interface 21 may provide a search window, and the administrator may search for information about items through the search window. The information about items may include information regarding items received in a logistics warehouse, items shipped, items returned, items under inspection, and so on. The inventory management interface 21 may generate a query requesting information about the items to be searched, entered through the search window, to the server 1, and transmit it to the server 1. The server 1 may derive information about the items to be searched from a database in response to the query and transmit it to the inventory management interface 21. The inventory management interface 21 may display the received information about the items on the administrator terminal 2. The inventory management interface 21 may provide a status inquiry window, and the administrator may inquire about receiving/shipping and return/inspection status through the status inquiry window. The inventory management interface 21 may transmit a status inquiry request input from the administrator to the server 1, and the server 1 may collect status information about items corresponding to the received status inquiry from the database and transmit it to the inventory management interface 21. The inventory management interface 21 may display the status information received by the administrator terminal 2 on the administrator terminal 2.

The inventory management interface 21 may display work lists for each of a plurality of workers on the administrator terminal 2. The administrator may modify or finally confirm a plurality of work lists for a plurality of workers through the inventory management interface 21. That is, the inventory management interface 21 may display the work lists provided from the server 1 and receive information regarding modification or confirmation of the work lists. The work list confirmed through the inventory management interface 21 may be transmitted to a worker terminal 3 of a corresponding worker. The work list for each of the plurality of workers may be generated by the server 1 and provided from the server 1 to the administrator terminal 2. The inventory management interface 21 may provide the confirmed work list to the administrator terminal 2, and the administrator terminal 2 may transmit the work list for each of the plurality of workers to the worker terminal 3. The administrator terminal 2 and the worker terminal 3 may be connected via a wireless network. Although the work list has been described as being generated by the server 1 in the foregoing description, the present invention is not limited thereto. A VMS driven by the server 1 may generate the work list, and if the VMS is driven by the administrator terminal 2, the administrator terminal 2 may generate the work list.

The personnel management interface 22 may provide an interface for managing personnel management information related to the attendance and work schedules of works working in the logistics center. When an inquiry for personnel information regarding a specific worker by an administrator is input, the personnel management interface 22 may request personnel management information for the specific worker to the server 1. In response to the request, the server 1 may collect the personnel management information for the specific worker from a database and transmit it to the personnel management interface 22. The personnel management interface 22 may request the server 1 to store some information in the database, modify some information stored in the database, or retrieve information stored in the database. Some information may include attendance information such as clock-in and clock-out for each worker, and information regarding work schedules for specific periods. The server 1 may store the personnel management information in the database.

The equipment management interface 23 may provide an interface for managing equipment information related to transportation equipment, CCTV, automation equipment, firefighting equipment, and the like located in the logistics center. The equipment management interface 23 may request an inquiry for the location of the equipment, information of the equipment, and the like from the server 1, and may display the equipment information received from the server 1. The server 1 may store the equipment information in the database.

The asset management interface 24 may provide an interface for managing asset information related to sales, profit and loss, orders, and the like of the logistics center. The asset management interface 24 may request an inquiry for asset information from the server 1, and may display the asset information received from the server 1. The server 1 may generate information regarding sales of the logistics center, information regarding profit and loss, information regarding orders, and the like, and store it in the database, collect the requested information from the database in response to a request from the asset management interface 24, and transmit the collected information to the asset management interface 24.

The center management interface 25 may provide an interface for managing center information related to center registration, center relocation, and the like. The center registration may refer to registering information about a new logistics center in the server 1, and the center relocation may refer to changing the logistics center displayed via the administrator terminal 2. The server 1 may store center information for each of a plurality of logistics centers in the database.

The message management interface 26 may provide an interface for managing message information related to message transmission and reception and transmitted/received message history between the administrator terminal 2 and the worker terminal 3 via the server 1. The message management interface 26 may request the server 1 to transmit a message to the worker terminal 3, or may receive a message transmitted from the worker terminal 3 to the server 1 from the server 1. The message management interface 26 may request the server 1 to inquire about message information, and may display the message information received from the server 1. The server 1 may store information about messages transmitted and received between the administrator terminal 2 and the worker terminal 3 in the database.

A plurality of equipment units are located within the logistics center, which are connected to an Internet of Things (IoT) server 4 via wireless communication. For example, CCTV, transportation equipment, automated equipment, firefighting equipment, and equipment carried by personnel may transmit and receive information wirelessly with the IOT server 4. The IoT server 4 may transmit and receive information with the CCTV using Real Time Streaming Protocol (RTSP), transmit and receive information with transportation equipment, automated equipment, and firefighting equipment using Message Queueing Telemetry Transport (MQTT) protocol or Kafka protocol, and transmit and receive information with the portable device using Real-time Locating System (RTLS).

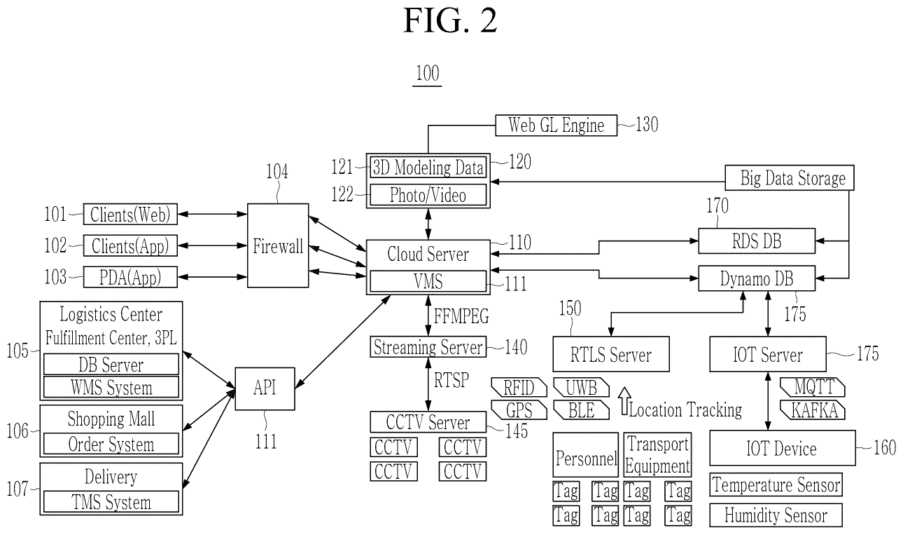

FIG. 2 is a block diagram illustrating the partial configuration of a logistics integrated management system according to an embodiment.

A 3D logistics integrated management system 100 may include a cloud server 110, a cloud storage 120, a WebGL engine 130, a streaming server 140, an RTLS server 150, an IOT server 160, an RDS DB 170, and a Dynamo DB 175.

The cloud server 110 may collect and process information to be provided in response to requests from each of the plurality of interfaces 21 to 26 described above from a database and provide the information to the plurality of interfaces 21 to 26. Additionally, the cloud server 110 may collect and process information provided in response to a request from the work terminal 3 from a database and provide it to the work terminal 3. The cloud server 110 may receive a plurality of requests from Clients (Web) 101, Clients (App) 102, PDA (App) 103, and the like through a firewall, and may transmit a plurality of responses to the plurality of requests to the Clients (Web) 101, the Clients (App) 102, the PDA (App) 103, and the like. A firewall 104 may be applied to the network between the cloud server 110 and the Clients (Web) 101, the Clients (App) 102, and the PDA (App) 103.

The cloud server 110 may transmit a plurality of requests to the streaming server 140, the RTLS server 150, the RDS DB 170, the Dynamo DB 175, and the like, and may receive a plurality of responses corresponding to the plurality of requests from the streaming server 140, the RTLS server 150, the RDS DB 170, the Dynamo DB 175, and the like. The cloud server 110 may transmit information requests to a WMS system 105 of a logistics center, an order system 106 of a shopping mall, a TMS (Transportation Management System) 107 of a delivery company, and the like, or may receive information transmitted from each system, via an API (Application Programming Interface) 111. In response to the information request from the cloud server 110, the WMS system 105 of the logistics center, the order system 106 of the shopping mall, the TMS 107 of the delivery company, and the like may derive corresponding information and transmit a response to the cloud server 110. An API 115 may be implemented as a separate communication device outside the cloud server 110, or may be implemented within the cloud server 110. The API 115 may determine one of the WMS system 105 of the logistics center, the order system 106 of the shopping mall, and the TMS 107 of the delivery company, corresponding to the information request from the cloud server 110, transmit the request, and transmit data received from the corresponding system in response to the request to the cloud server 110.

The cloud storage 120 may store 3D modeling data 121 related to a 3D model that models the logistics center in 3D, and photos/videos 122 regarding the logistics center. The 3D model may include 3D objects representing objects such as a plurality of racks configuring the logistics warehouse, items placed on the plurality of racks, equipment such as transportation equipment located in the logistics warehouse, firefighting facilities, and workers. The 3D modeling data 121 may include 3D image data for such 3D objects. The 3D image data refers to image data for displaying 3D objects as 3D images on a display device of the administrator terminal 2 or the work terminal 3. The photos/videos 122 of the logistics center may include a plurality of photos taken of a plurality of areas obtained by dividing the interior of the logistics center into units of a predetermined size, photos of various types of items located in the logistics center, videos obtained by CCTV, and the like. The cloud server 110 may store the photos/videos 122 in the cloud storage 120 and may request necessary photos and videos from the cloud storage 120. The cloud storage 120 may read the corresponding photos and videos in response to the request and provide them to the cloud server 110. The 3D logistics integrated management system 100 may store large-capacity 3D modeling data using the cloud storage 120.

The WebGL engine 130 may generate 3D modeling data for implementing the interior of the logistics center and various objects provided within the logistics center as a 3D model by 3D modeling, and may upload the 3D modeling data to the cloud storage 120.

The cloud server 110 may transmit a request for CCTV video to the streaming server 140, and the streaming server 140 may transmit the CCTV video in response to the request. The streaming server 140 transmits a request according to RTSP to a CCTV server 145, which is a local server, and the CCTV server 145 transmits CCTV video data according to RTSP to the streaming server 140. The CCTV server 145 may be connected to a plurality of CCTVs and may control the plurality of CCTVs to collect video obtained by the plurality of CCTVs. The streaming server 140 may convert CCTV video data obtained from the CCTV server 145 into FFMPEG and transmit it to the cloud server 110.

The RTLS server 160 may track the location of tags assigned to personnel such as workers located in the logistics center and tags attached to transportation equipment, using UWB (Ultra-wideband), BLE (Bluetooth Low Energy), GPS (Global Positioning System), RFID (Radio Frequency Identification), and the like. The RTLS server 160 may collect location data of personnel or transportation equipment in the logistics center and transmit it to the Dynamo DB 175. The Dynamo DB 175 may store the received location data in the cloud storage 120 as big data units. When the client server 110 receives a request for the real-time location of personnel or transportation equipment from a client, it may request the location information of the corresponding personnel or transportation equipment from the Dynamo DB 175. The Dynamo DB 175 may obtain the real-time location of the corresponding personnel or transportation equipment by requesting it from the RTLS server 150 in response to the request.

The RTLS server 150 may periodically collect movement data of objects within the logistics center, such as personnel or transportation equipment. The location data collected in this way may be stored in the cloud storage 120 as a big data unit, and may be used by the RTLS server 150 for machine learning to predict the location of the object. The RTLS server 150 may build a location prediction model through machine learning using location data. Such a location prediction model may be used for developing solutions for predicting the location of an object, analyzing movement paths, or determining optimal rack placement. Since it is expensive for the Dynamo DB 175 to have data that takes up a long time, location data may be stored as big data units in the cloud storage 120 that is relatively inexpensive. The data stored in this way may be utilized for developing various solutions.

The IOT server 160 may transmit information regarding an IOT device in response to a request from the Dynamo DB 175. The IOT server 160 may be implemented through an IOT management service provided by AWS (Amazon Web Service). IOT devices may include temperature sensors, humidity sensors, and the like. The IOT server 160 may transmit and receive information with the IOT device via an MQTT protocol or Kafka. The IOT server 160 may receive messages from the IOT device or send messages to the IOT device, and may transmit IOT information received from the IOT device to the Dynamo DB 175. Kafka and MQTT may be communication protocols that can be used to transmit and receive messages. Kafka may be applied between an automated device, which is one of the IOT devices within a logistics center, and the IOT server 160, so that status information regarding the automated device may be transmitted from the automated device to the IOT server 160, or control information for controlling the automated device may be transmitted from the IOT server 160 to the automated device. The status information of the automated device may include whether the automated device is operating, information regarding operations performed by the automated device, and the like.

The RDS DB 170 and the Dynamo DB 175 may provide data corresponding to a request to the cloud server 110 in response to the request from the cloud server 110. The RDS DB 170 may store data related to the operation of the logistics center, for example, data regarding inventory, inbound/outbound shipments, orders, and the like. The Dynamo DB 175 may store and manage unstructured data provided from the RTLS server 150 and the IOT server 160. The IOT server 160 may transmit IOT information to the Dynamo DB 175 at regular intervals. The Dynamo DB 175 may store the corresponding IOT information only for a certain period and transmit IOT information corresponding to a request to the client server 110 in response to a request from the client server 110. The Dynamo DB 175 may perform auto-scaling according to the amount of IOT data, and thus may be a suitable database for managing messages generated from various IOT equipment.

The configuration of the 3D logistics integrated management system 100 shown in FIG. 2 is an example for describing the invention, and the invention is not limited thereto. The server 1 shown in FIG. 1 may include the cloud server 110, the cloud storage 120, and the WebGL engine 130. Additionally, the server 1 may further include at least one of the streaming server 140, the RTLS server 150, the IOT server 160, the RDS DB 170, and the Dynamo DB 175.

The 3D logistics integrated management system 100 according to some embodiments may use a 3D model that models a logistics warehouse in 3D. The 3D model may be used by an administrator to monitor the logistics warehouse and generate work lists. In generating the 3D model, 3D modeling should be lightweight. The 3D logistics integrated management system may automatically generate and delete 3D boxes on 3D racks of the 3D model in real-time based on inbound/outbound data. Then, real-time inventory generation and deletion may be implemented in 3D. In addition, the 3D logistics integrated management system may implement adding and deleting 3D assets by adding or deleting 3D racks or 3D modeling data to the 3D model. The 3D logistics integrated management system may arrange 3D assets corresponding to people and various equipment within the logistics warehouse into the 3D model, and map them with data from a database to display information queries and real-time locations in the 3D model.

The cloud server 110 may include a VMS 111. The VMS 111 may be implemented as software for collecting data based on a plurality of requests and corresponding responses generated in logistics management, and processing the collected data to generate output. The VMS 111 may be installed on the administrator terminal 2 instead of the cloud server 110. The cloud server 110 or the administrator terminal 2 may execute the VMS 111 to provide various functions necessary for logistics management. When the VMS 111 is installed on the cloud server 110, the administrator may access the VMS 111 on the web by entering an administrator ID and password on an Internet page. A VMS operating on the web may be referred to as Web VMS. When the VMS is installed on the administrator terminal 2, the administrator may use the VMS on the administrator terminal 2. In FIG. 2, the client 101 may be the administrator terminal 2. Management tasks provided by the VMS 111 may include inventory management, personnel management, equipment management, asset management, center management, message management, productivity functions, and so forth. The productivity functions include inbound/outbound location recommendation, status monitoring, work history, search functions, and so forth. The VMS 111 operates on the cloud server 110 or the administrator terminal 2, and the VMS 111 may provide an inventory management interface 21, a personnel management interface 22, an equipment management interface 23, an asset management interface 24, a center management interface 25, and a message management interface 26 to the administrator terminal 2.

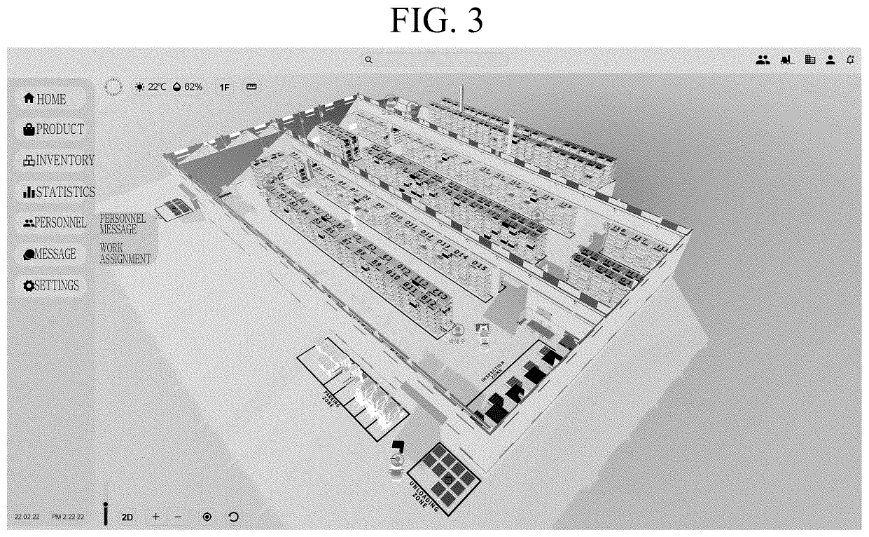

FIG. 3 is a drawing illustrating a 3D screen provided during operation of a virtual management system driven on the web according to an embodiment.

The 3D screen shown in FIG. 3 may be produced in a Web 3D environment that may operate on all OSs. The 3D screen shown in FIG. 3 shows the interior of a logistics center in three dimensions. The 3D screen shown in FIG. 3 may be a 3D logistics center created using WebGL. Screen movement, rotation, zoom in, zoom out, camera reset, distance measurement, layer-by-layer movement, and movement of logistics centers can be displayed in the 3D environment. In the present specification, “moving a 3D screen to a certain location” may include configuring the screen around a certain location, moving the center of the screen to a certain location, or configuring the screen to display information of an object corresponding to a certain location, and so forth.

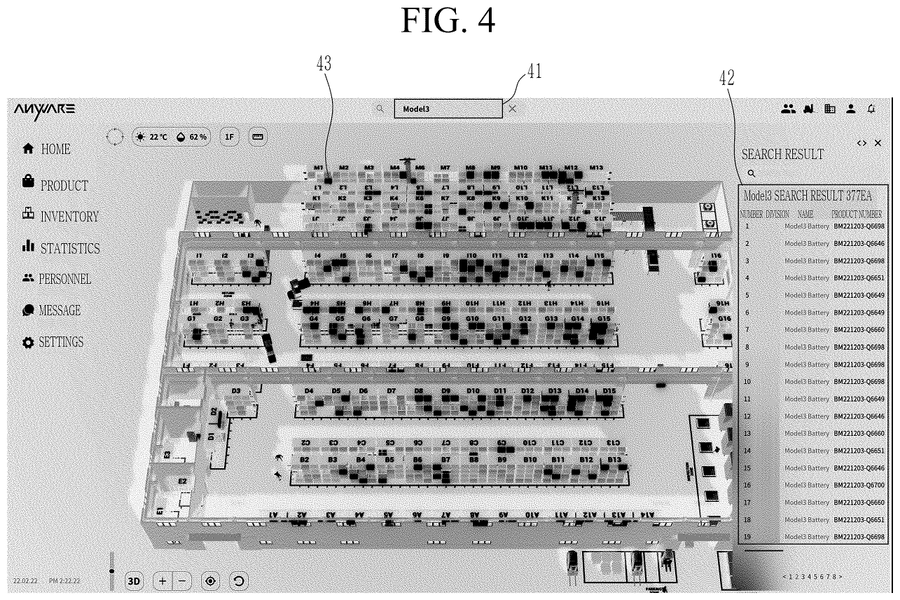

FIG. 4 is a drawing showing inventory search results through Web VMS.

The 3D screen shown in FIG. 4 may be provided by the inventory management interface 21.

In the 3D screen shown in FIG. 4, a search term input field 41 may be located. The screen shown in FIG. 4 is a search result window displaying the search result for the search term “Model3.” As shown in FIG. 4, on a 3D screen modeling the interior of a logistics center, the color of an inventory box corresponding to a product search result, that is, “Model3,” may be displayed differently from other boxes. For example, an area marked “43” in FIG. 4 is distinguished from the colors of other areas, and a “Model3” inventory box is located in that area 43. The inventory management interface 21 may list items according to search results in the right area 42 of the 3D screen. When one of the items listed in the area 42 is selected, the inventory management interface 21 may move the 3D screen to the box corresponding to the selected item. Subsequently, an item information window pop-up displaying corresponding item information may be activated.

The inventory management interface 21 may display different colors of boxes indicating items on the 3D screen depending on the current status of the item (during receiving, receiving completed, during shipping, shipping completed, return, inspection). The inventory management interface 21 may change the color of the box for items that matches the search result on the 3D screen. When an item in the listed up item list 42 is clicked, the 3D screen may move to the location of the corresponding item, and an item information window may open. As such, because inventory search is possible on the 3D screen, intuitive and quick item location confirmation and item information identification may be possible.

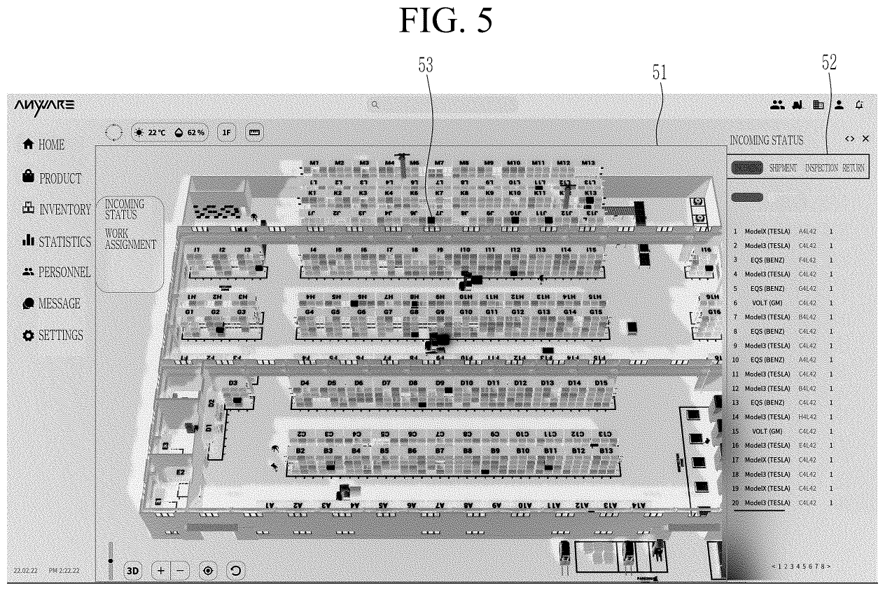

FIG. 5 is a drawing showing status monitoring results through Web VMS.

The 3D screen shown in FIG. 5 may be provided by the inventory management interface.

As shown in FIG. 5, the inventory management interface 21 may provide an inventory status window 51, which is a 3D screen, and may provide selection areas in an area 52 of the inventory status window 51 from which one of receiving, shipping, inspection, and return can be selected. In FIG. 5, a state where “receiving” is selected and the inventory status window 51 showing the status of received goods is opened, is illustrated. In the inventory status window 51, the locations of the received goods are displayed. For example, in FIG. 5, the received goods may be displayed as a box indicated by “53”. The inventory management interface 21 may provide different colors for boxes displaying goods in the inventory status window 51 according to the current status of the goods, such as during receiving, receiving complete, during shipping, shipping complete, return, or inspection.

Since status monitoring is possible on a 3D screen in this way, an administrator may intuitively grasp the real-time work status. Through this, work efficiency may be improved.

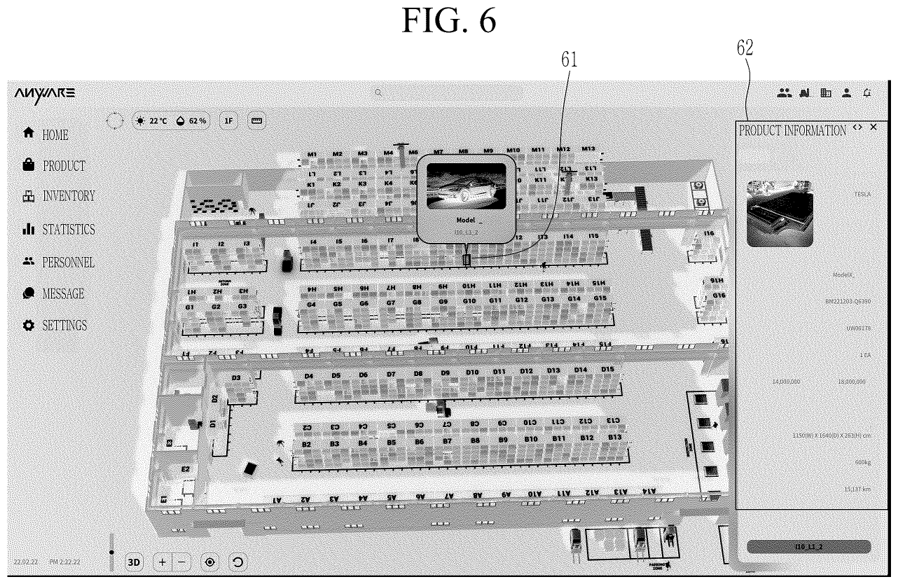

FIG. 6 is a drawing showing an item tooltip provided through Web VMS.

The 3D screen shown in FIG. 6 may be provided by the inventory management interface.

As shown in FIG. 6, when a cursor is placed over a box 61, a picture, information, and location of an item corresponding to the box may be retrieved. Subsequently, when a click is input on the box where the cursor is placed, a product information window 62 may be opened, and the picture, information, and location of the product retrieved in the product information window 62 may be displayed. In this manner, real-time retrieval of items located in the logistics center is possible, thereby reducing the time required for item retrieval.

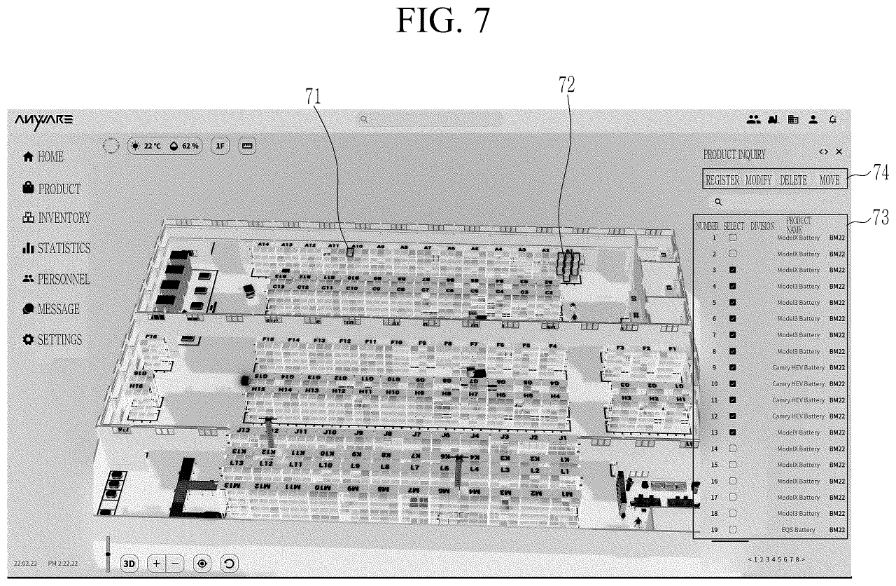

FIG. 7 is a drawing showing item inquiry provided through Web VMS.

The 3D screen shown in FIG. 7 may be provided by the inventory management interface 21.

The administrator may retrieve, modify, and delete detailed information of items stored in the logistics center via the inventory management interface 21. In a product retrieval result window 73 of the screen shown in FIG. 7, the locations of items checked with a “ [symbol] ” mark may be displayed distinctively from other items, such as “71” and “72”, in the 3D screen. [symbol] Through this, it is possible to confirm the locations of the checked items on the 3D screen. The inventory of the logistics center may be intuitively confirmed.

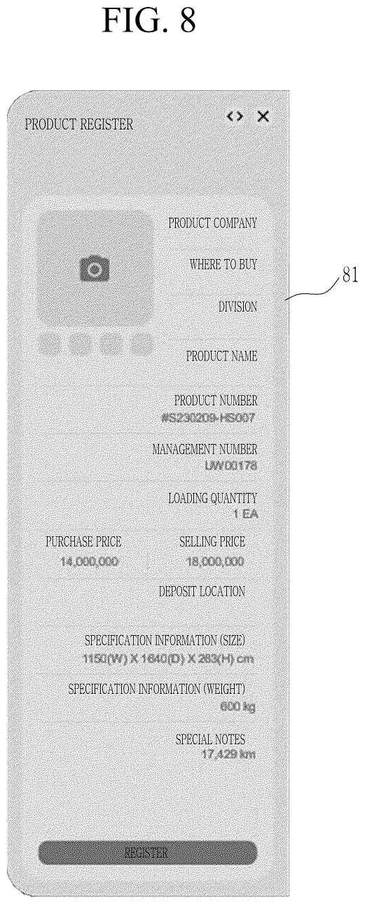

FIG. 8 is a drawing showing item registration provided through Web VMS.

The 3D screen shown in FIG. 8 may be provided by the inventory management interface 21.

New received products may be registered via the screen shown in FIG. 8. The area 74 shown in FIG. 7 includes selectable areas for “Product Registration,” “Product Modification,” “Product Deletion,” and “Product Movement.” When the administrator selects “Product Registration,” a product registration window 81 shown in FIG. 8 may be displayed. The product registration window 81 may allow input of information such as product company, supplier, category, product name, product number, management number, loading quantity, purchase price, sales price, receiving location, specification information (size, weight), and special notes.

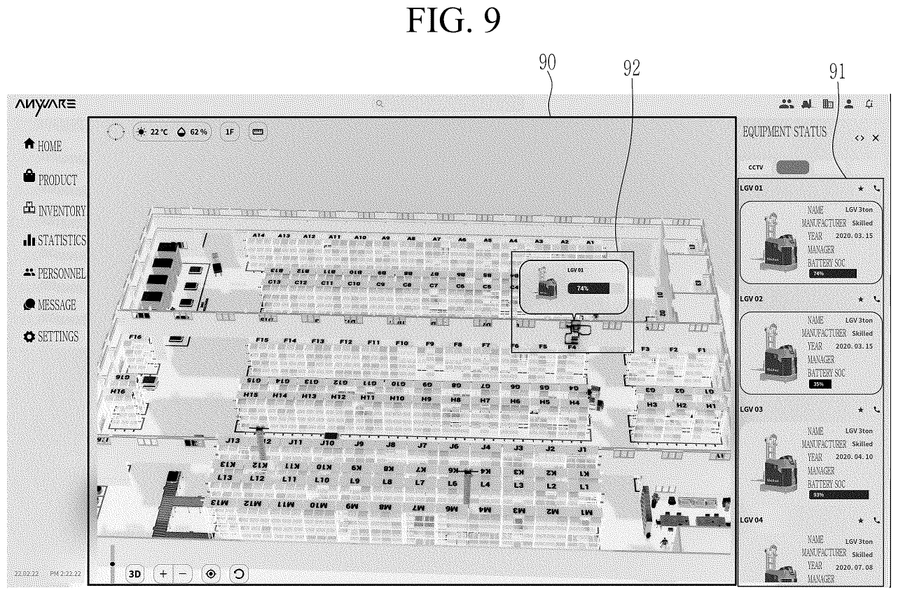

FIG. 9 is a drawing showing equipment monitoring provided through Web VMS.

A 3D screen 90 shown in FIG. 9 may be provided by the equipment management interface 23.

The equipment management interface 23 according to Web VMS may provide a window (hereinafter, equipment status window) 91 showing equipment currently operating in the logistics center, on the right of the 3D screen 90. The equipment management interface 23 may list equipment in the equipment status window 91, display the location of equipment selected by the administrator on the 3D screen 90 of the 3D-implemented interior of the logistics center, and move the 3D screen 90 to the location of the selected equipment. For example, when the administrator selects “LGV01,” the corresponding equipment may be displayed in the 3D screen 90 as an area 92. In the area 92, the monthly average operating rate of the equipment, the year of the equipment (20-year model), the administer (Moon Seon-ju in charge), the battery SOC(State of Charge) (74%), and the like may be displayed. The equipment status window 91 may display the equipment name (LGV 3ton), manufacturer (Skilled), manufacturing year (2020 Mar. 15), administrator (Manager Moon Seon-ju), battery status (74%), and the like. In addition, repair history and the like be displayed in the equipment status window 91 or area 92. In this way, the administrator may grasp and monitor the equipment operation status within the logistics center in real time. This will enable accident prevention plans and equipment operation plans to be established.

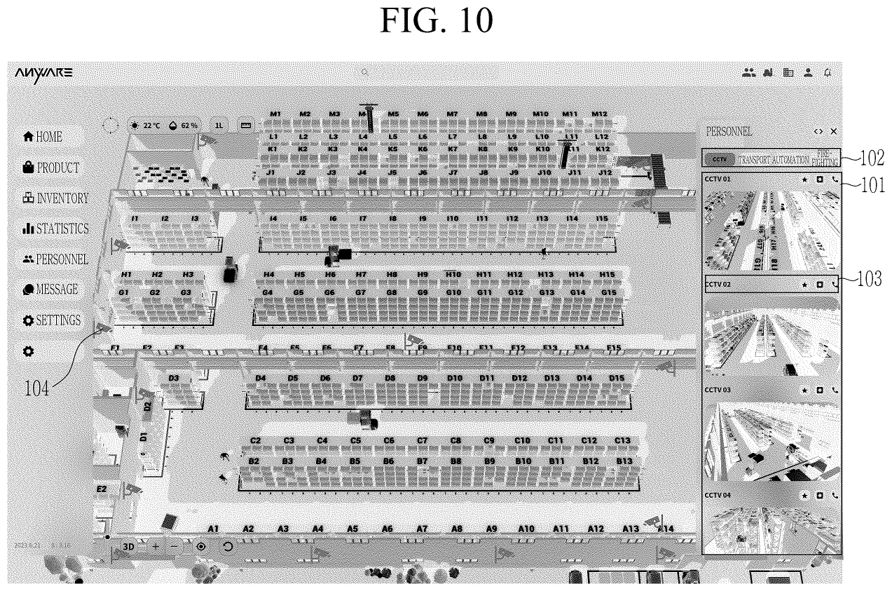

FIG. 10 is a drawing showing CCTV monitoring provided through Web VMS.

The 3D screen shown in FIG. 10 may be provided by the equipment management interface 23.

The equipment management interface 23 according to the Web VMS may provide an area 102 capable of selecting one of equipment statuses located in a logistics center, for example, CCTV, transportation equipment, automation equipment, and firefighting equipment. When CCTV is selected in the area 102, the equipment management interface 23 may display the locations of a plurality of CCTVs installed in the logistics center on the 3D screen, and may display a 3D image of the area covered by each of the plurality of CCTVs in a CCTV list window 101. The equipment management interface 23 may display footage of CCTVs selected by the administrator among the CCTVs listed in the CCTV list window 101. For example, when the administrator selects a CCTV in the list window 101, the equipment management interface 23 may request CCTV video data captured by the selected CCTV from a cloud server 110. When the CCTV video data is received by the equipment management interface 23 from the cloud server 110 in response to the request, the equipment management interface 23 may display the received CCTV video data. The administrator may specify a shooting period for the CCTV through the equipment management interface 23. The equipment management interface 23 may transmit information regarding the selected CCTV and the shooting period to the cloud server 110. The cloud server 110 may request video data from a streaming server 140 along with information about the received CCTV and shooting period. The streaming server 140 may request video for the shooting period of the selected CCTV from a CCTV server 145. The CCTV server 145 may transmit video for the shooting period of the selected CCTV to the streaming server 140 in response to the request, and the streaming server 140 may convert the video into FFMPEG and transmit it to the cloud server 110. The cloud server 110 may provide the received video data to the VMS 111, and the VMS 111 may display the corresponding video on the administrator terminal 2 via the equipment management interface 23.

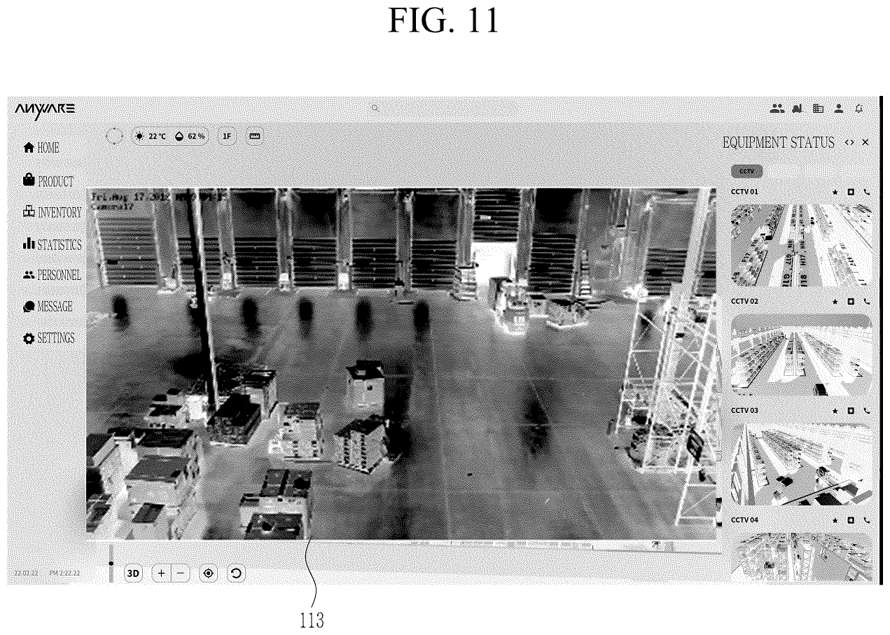

FIG. 11 is a drawing showing CCTV video provided through the administrator terminal.

The administrator may select “CCTV2” in the CCTV list window 101 or directly select “CCTV2” 104 on the 3D screen. Then, as shown in FIG. 11, the equipment management interface 23 may display the “CCTV2” video data provided from the cloud server 110 on the screen 113.

The equipment management interface 23 may provide monitoring of automation equipment, firefighting equipment, and the like to the administrator from the administrator terminal 2. For automation equipment monitoring, the equipment management interface 23 may display a window showing a list of automation equipment installed in the center on the administrator terminal 2 in a manner similar to the CCTV list window 101 shown in FIG. 10. The equipment management interface 23 may display the real-time operation rate and status of automation equipment in the corresponding window. An automation equipment may be selected by the administrator from among the automation equipment displayed in the corresponding window. Then, the equipment management interface 23 may display a location corresponding to the selected automation equipment on the 3D screen and may move the 3D screen to the corresponding location. By monitoring the logistics automation equipment using the equipment management interface 23, the administrator may manage the real-time work status for each logistics stage and predict the work status.

For firefighting equipment monitoring, the equipment management interface 23 may display a window showing a list of IoT firefighting equipment installed in the center on the administrator terminal 2 in a manner similar to the CCTV list window 101 shown in FIG. 10. The equipment management interface 23 may ensure that firefighting equipment operation commands may be executed normally in the event of a fire through real-time inspection of the firefighting equipment. Firefighting equipment may be selected by the administrator from among the firefighting equipment displayed in the window showing the list of firefighting equipment. Then, the equipment management interface 23 may display a location corresponding to the selected firefighting equipment on the 3D screen and may move the 3D screen to the corresponding location. By real-time monitoring of the firefighting equipment using the equipment management interface 23, the administrator may respond to a fire at an early stage of a fire accident.

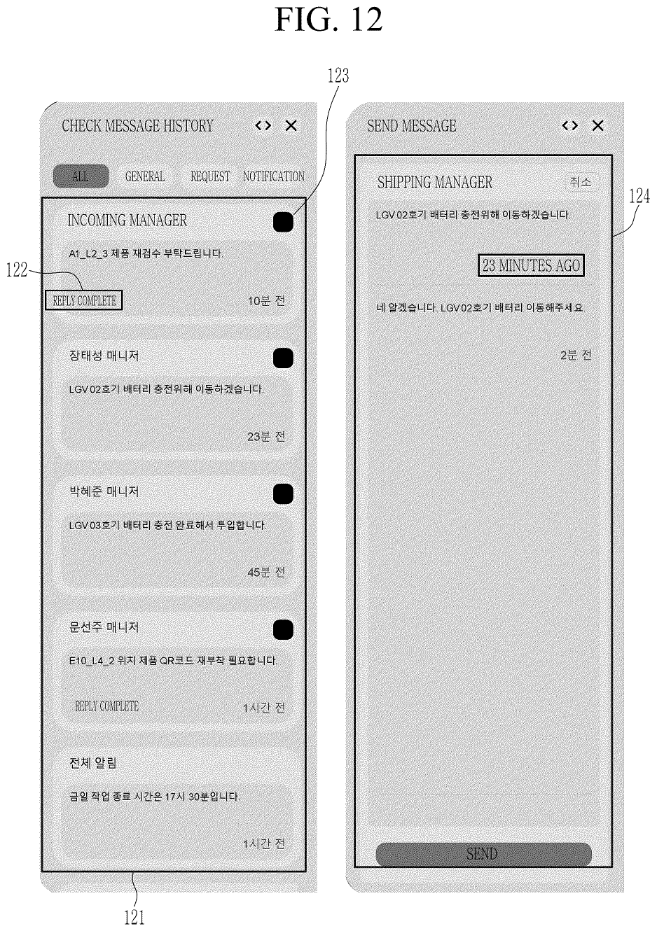

FIG. 12 is a drawing showing a message list and a message sending window displayed by Web VMS via an administrator terminal.

The screen shown in FIG. 12 may be provided by the message management interface 26.

The Web VMS 111 may transmit messages received from the administrator terminal 2 to the worker terminal 3, and may transmit messages received from the worker terminal 3 to the administrator terminal 2. This enables two-way communication between the administrator and the worker. The message management interface 26 may provide a message history confirmation window 125 that arranges messages transmitted and received between the administrator terminal 2 and a plurality of worker terminals 3 in chronological order. When a response from the worker terminal 3 is received for a message (transmitted message) transmitted from the administrator terminal 2, “Response Completed” 126 and “ [symbol] ” 123 may be displayed. The message management interface 26 may provide a message sending window 124 for transmitting messages to a specific worker. The message sending window 124 may show messages transmitted to a specific worker in chronological order. As such, communication errors may be reduced through rapid communication between the administrator and the worker via the message management interface 26.

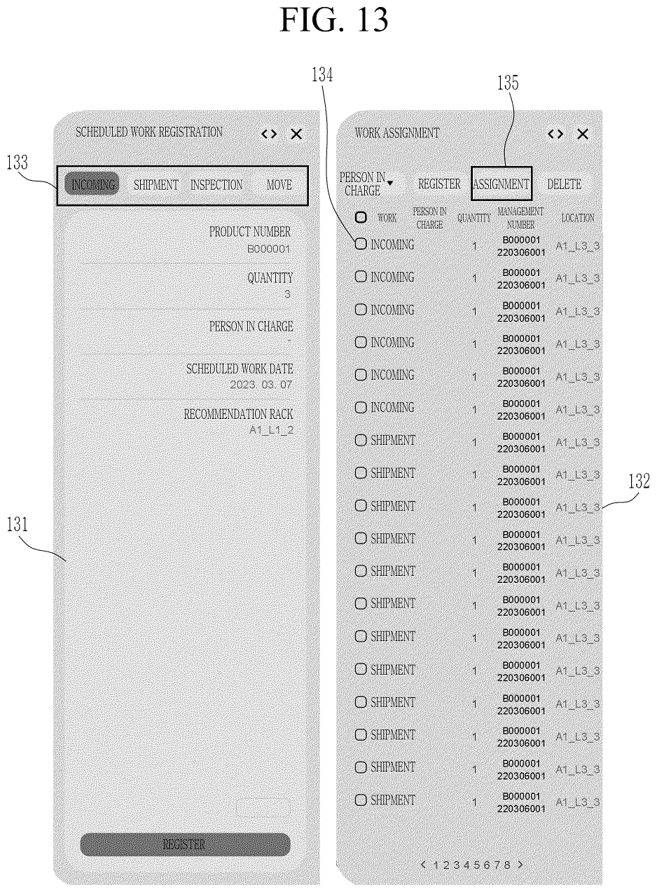

FIG. 13 is a drawing showing a task registration window and a task assignment window displayed by Web VMS via an administrator terminal.

The screen shown in FIG. 13 may be provided by the personnel management interface 22.

The Web VMS 111 may provide the personnel management interface 22 to enable an administrator to perform work registration and work assignment through the administrator terminal 2 by collecting and processing information necessary for work registration and work assignment. For example, the personnel management interface 22 may display a work registration window 131 on the administrator terminal 2 for registering work to be processed. The administrator may register work to be processed on a specific date (for example, the day after the work registration date) based on an order form. The administrator may select tasks to be registered from “receiving,” “shipping,” “inspection,” and “movement” displayed in an area 133.

The personnel management interface 22 may display the task list window 132 showing the registered task list through the administrator terminal 2. The administrator may select a certain task from the task list window 132 and select a worker to perform the selected task from a plurality of workers. The personnel management interface 22 may provide a box (for example, 134) for selecting one of a plurality of tasks arranged in the task list window 132. The personnel management interface 22 may provide information such as task type (receiving, shipping, and the like), person in charge, quantity, management number, and location for each task in the task list window 132. When the box 134 is checked in the task list window 132 and “Assign” 135 is selected, the personnel management interface 22 may transmit information about the selected taks to the Web VMS 111, and the Web VMS 111 may assign the checked task to the person in charge (“Moon Seon-ju”) of the selected task. The Web VMS 111 may push-notify the corresponding task to a worker terminal corresponding to the person in charge of the selected task. In this way, work efficiency may be increased by pre-registering a task through the personnel management interface 22 and assigning the selected task to a worker.

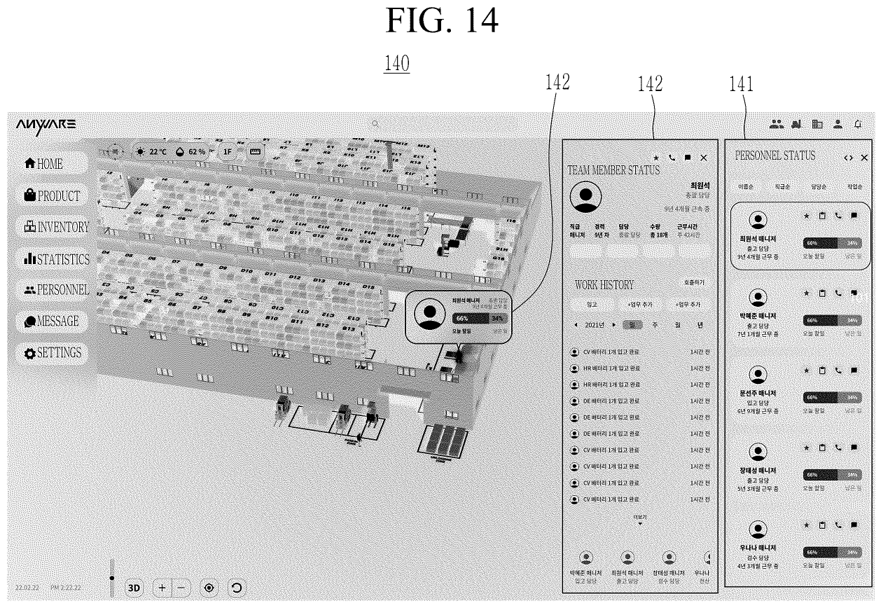

FIG. 14 is a drawing showing a personnel management window displayed by Web VMS via an administrator terminal.

The screen shown in FIG. 14 may be provided by the personnel management interface 22.

The Web VMS 111 may provide the personnel management interface 22 to the administrator terminal 2 to enable the administrator to perform personnel management by collecting and processing information necessary for personnel management. The personnel management interface 22 may display the personnel management window 140 through the administrator terminal 2. The administrator may register, modify, and delete workers working in a logistics center through the personnel management window 140. The administrator may inquire about worker information in the personnel management window 140, inquire about a list of tasks performed by the worker for a predetermined period, and change the system authority of the worker. The personnel management interface 22 may provide a personnel status list 141 showing the status of workers working in the logistics center. When the administrator selects a worker from the personnel status list 141, the personnel management interface 22 may provide a personnel information window 142 including information about the selected worker. The personnel information window 142 may display the selected worker's position, career, assigned tasks, working hours, and work history. The personnel management interface 22 may move a 3D screen to a location 143 of the selected worker. The window of the location 143 may display the worker's name, amount of work processed, and remaining amount of work as a graph. The administrator may perform planned and efficient work management for each worker by inquiring about each worker's work history.

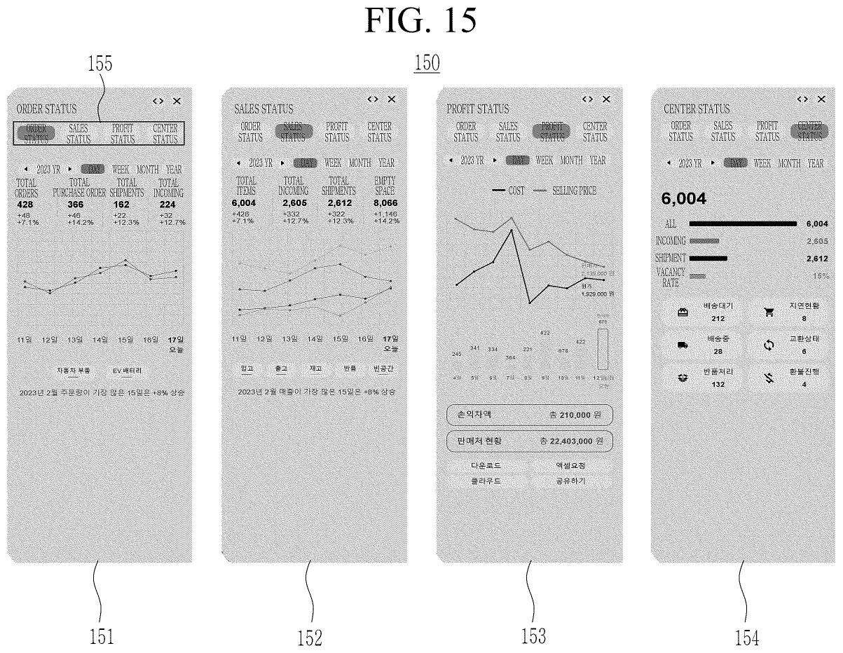

FIG. 15 is a drawing showing an asset management window displayed by Web VMS via an administrator terminal.

The screen shown in FIG. 15 may be provided by the asset management interface 24.

The Web VMS 111 may provide the asset management interface 24 to enable an administrator to perform asset management through the administrator terminal 2 by collecting and processing information necessary for asset management. The asset management interface 24 may display an asset management window 150 on the administrator terminal 2. The asset management interface 24 may provide at least one of number of orders by period, vacancy rate, number of receiving items, number of shipping items, number of returned items, logistics center sales statistics, logistics center profit and loss, and real-time statistics of a logistics center (orders, receiving, shipping, returns). The administrator may inquire about and monitor various asset statuses provided by the asset management interface 24 through the administrator terminal 2. The asset management window 150 displays an area 155 where one of “Order Status,” “Sales Status,” “Profit Status,” and “Center Status” may be selected

When the administrator selects “Order Status,” the asset management interface 24 may provide an order status window 151 displaying the order status of each product by period (day, week, month, year, or the like) as a graph. The asset management interface 24 may display information such as total number of orders, total purchase orders, total shipping items, and total receiving items by period (day, week, month, year, or the like) together in the order status window 151.

When the administrator selects “Sales Status,” the asset management interface 24 may provide a sales status window 152 displaying information about receiving, shipping, inventory, returns, and vacant space by period (day, week, month, year, or the like) as a graph. The asset management interface 24 may display information such as total number of products, total receiving items, total shipping items, and vacant space by period (day, week, month, year, or the like) together in the sales status window 152.

When the administrator selects “Profit Status” in the sales status window 152, the asset management interface 24 may provide a profit status window 153 displaying sales prices and costs by period (day, week, month, year, or the like) as a graph. The asset management interface 24 may display information such as profit and loss difference and sales location status by period (day, week, month, year, or the like) together in the profit status window 153. The profit and loss difference by period is the sum of sales prices minus the sum of costs for the corresponding period, and the sales location status by period is the sum of sales prices for the corresponding period.

When the administrator selects “Center Status,” the asset management interface 24 may provide a center status window 154 displaying the overall status, receiving status, shipping status, and vacancy rate of the logistics center by period (day, week, month, year, or the like). The asset management interface 24 may display information such as delivery pending, in delivery, return processing, delay status, exchange status, and refund in progress by period (day, week, month, year, or the like) together in the center status window 153.

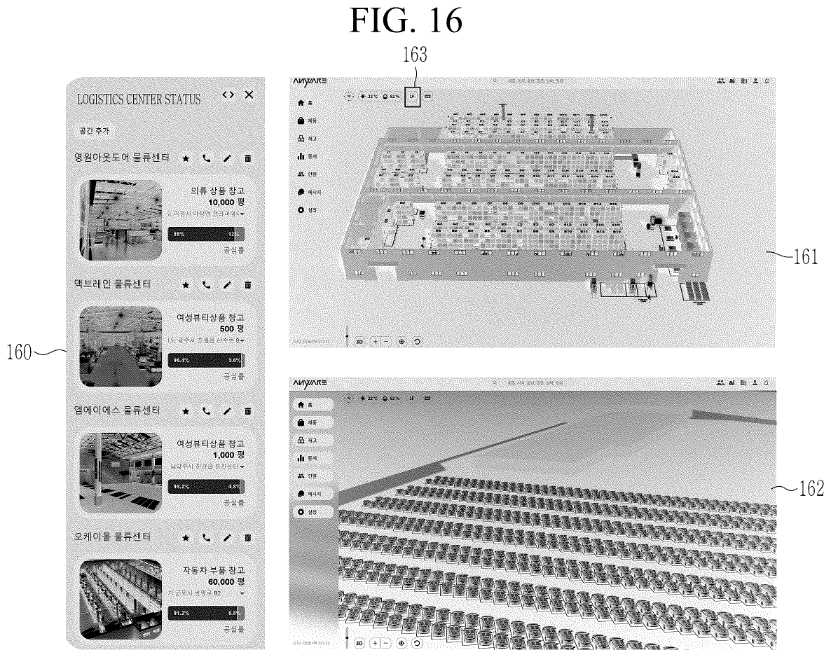

FIG. 16 is a drawing showing a logistics center management window displayed by Web VMS via an administrator terminal.

The screen shown in FIG. 16 may be provided by the center management interface 25.

The Web VMS 111 may collect and process information necessary for logistics center management to provide the center management interface 25 to allow the administrator to manage logistics centers via the administrator terminal 2. The center management interface 25 may display the logistics center status window 160 through the administrator terminal 2. The center management interface 25 may configure and display the logistics center status window 160 on the administrator terminal 2 based on information regarding multiple logistics centers registered in the 3D logistics integrated management system 100. The logistics center status window 160 may display the name, address, size, inventory rate, vacancy rate, and product types of each logistics center. The administrator may select one of the multiple logistics centers through the logistics center status window 160. The center management interface 25 may display 3D screens 161 and 162 of the selected logistics center on the administrator terminal 2. The administrator may register a new logistics center or modify information about a registered logistics center through the logistics center status window 160. Through this logistics center management window, it is possible to easily manage multiple logistics centers from one place without having to go there directly.

Additionally, the administrator may request information regarding other floors of a selected logistics center from the 3D screens 161 and 162 of the selected logistics center. For example, a floor number (for example, “1F”) may be displayed in an area 163 on the 3D screen 161, and the administrator may change the floor number of the area 163. The center management interface 25 may request information regarding the changed floor number from the cloud server 110. The Web VMS 111 may receive information regarding other floors from the cloud server 110 and provide it to the administrator terminal 2 via the center management interface 25. The center management interface 25 may display 3D screens of other floors on the administrator terminal 2. In this way, the administrator may perform floor-by-floor movement through the 3D screen provided via the administrator terminal 2.

The administrator may select one of a plurality of logistics centers registered in the Web VMS 111 via the administrator terminal 2. The Web VMS 111 may provide the aforementioned plurality of interfaces for the selected logistics center. The administrator may select one of the plurality of logistics centers via the administrator terminal 2 and proceed with logistics center management tasks through the aforementioned plurality of interfaces in the selected logistics center. After searching for an item, the 3D screen may be moved to the location of the searched item. That is, the administrator may request a 3D screen movement to the working location of a searched person after searching for a person in the selected logistics center via the administrator terminal 2, or request a 3D screen movement to the location of a searched equipment after searching for equipment, or request a 3D screen movement to the location of a searched CCTV after searching for a CCTV. Additionally, the administrator may bookmark frequently visited locations using any interface (for example, the center management interface) and then select the bookmark to request 3D screen movement to the frequently visited location. Each request is transmitted to the Web VMS 111 via a corresponding interface, and the Web VMS 111 may collect information from the cloud server 110 to respond to the request. The Web VMS 111 processes the collected information and may provide the processing results as a 3D screen on the administrator terminal 2 via the interface corresponding to each request. In this way, the administrator may easily perform management of each of the plurality of logistics centers at any time via the administrator terminal 2.

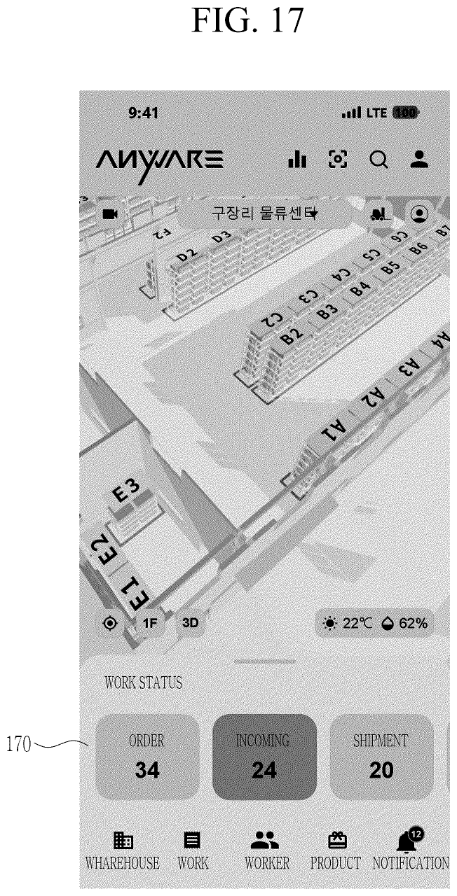

FIG. 17 is a drawing showing a 3D screen provided on a worker terminal.

The worker terminal 3 may be a smartphone, PDA, tablet, or the like, and an application (hereinafter referred to as “practical application”) may be installed on the worker terminal 3 to collect and process information provided by the 3D logistics integrated management system 100 and display it on the worker terminal 3, to collect and process information input into the worker terminal 3 and transmit it to the cloud server 110, and to display information received from the cloud server 110. The 3D screen provided through the practical application on the worker terminal 3 may be generated through lightweight 3D modeling.

A worker may perform real-time 3D inventory creation/deletion, 3D asset addition/deletion, data mapping, and the like through the 3D screen 170 of the worker terminal 3. The practical application may create and delete boxes in real time in a 3D rack on a 3D screen 170 based on receiving and shipping data. This is referred to as 3D inventory creation/deletion. The practical application may add or delete 3D racks or 3D modeling data on the 3D screen 170 based on changes in the layout of internal structures, such as structural changes within the logistics center, or the addition or relocation of racks. This is referred to as 3D asset addition/deletion. On the 3D screen 170, 3D assets such as people and various equipment are arranged in a 3D environment, and data from a database corresponding to each of the arranged 3D assets may be mapped through the practical application. When data mapping is completed, the worker may query necessary information and view the real-time location of personnel, items, equipment, and the like, through the worker terminal 3. In the present disclosure, lightweight 3D modeling may be performed in a Web 3D environment using WebGL. The worker may be provided with functions such as screen movement, rotation, zooming in, zooming out, camera reset, distance measurement, floor-by-floor movement, and center movement on the 3D screen 170. Camera reset means that the focus of the camera on the logistics center returns to a set origin. A 3D screen is configured by modeling the logistics center in 3D as if the logistics center was photographed with a camera, and the focus of the camera photographing the logistics center is virtually set, and the area corresponding to the set focus is displayed on the 3D screen 170. Camera reset means that the focus of the virtual camera returns to a set origin that covers the entire logistics center. Distance measurement means that the distance between any two objects on the 3D screen 170 is displayed as a real distance.

The 3D screen 170 shown in FIG. 17 is a work status window that can display orders, receipts, shipments, and the like, to be processed by the worker.

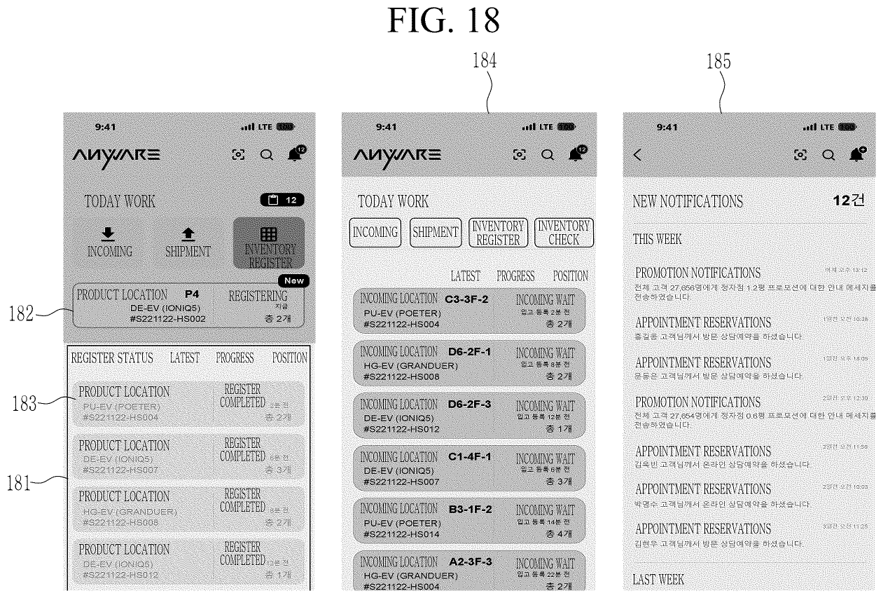

FIG. 18 is a drawing showing a screen provided on a worker terminal for the worker's task progression.

In FIG. 18, a screen 181 is a practical application home screen. The screen 181 may display the work progress status. The work progress status can include a list of receiving/shipping statuses processed by workers, a list of receiving/shipping statuses in progress, and the like.

In the area 182 on the screen 181, the task currently in progress is displayed, and the worker may check the task currently in progress by touching the area 182. The area 183 on the screen 181 displays a list of logistics center task statuses. The area 183 may display the progress status of today's logistics center tasks (receiving, shipping, inspection, and return). In the area 183, the task progress status may be displayed as “Registration Complete” or “Registration in progress.”

The screen 184 may display a list of tasks assigned to the worker today and their progress. The screen 184 is a screen when “receiving” is selected. The receiving location and receiving status (for example, “Receiving pending”) of the product may be displayed on the screen 184 along with the number of products and the estimated receiving registration time (for example, “2 minutes before receiving registration”). Messages from the administrator via the administrator terminal 2 may be displayed as a push notification on the screen 185. The screen 185 may display the title of the pushed message, the message content, the push notification time, and the like. As such, the workers may quickly grasp and execute their work content through the screens provided by the application and proceed with tasks by receiving messages from the administrator.

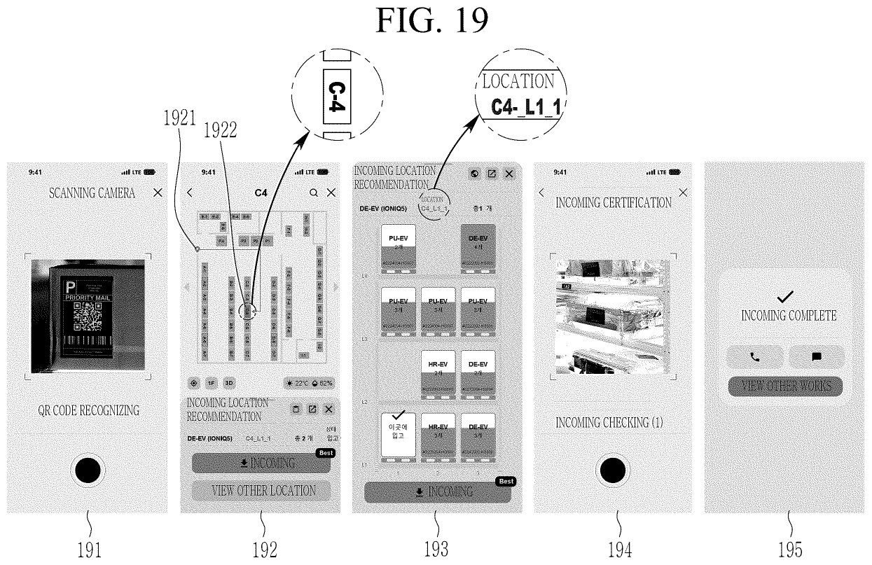

FIG. 19 is a drawing showing a receiving task progress screen provided on a worker terminal.

As shown in a screen 191, the worker may scan the QR/barcode/RFID attached to the item using the worker terminal 3. By pressing a “receiving” button on a screen provided via the worker terminal 3 (for example, 181 of FIG. 18), it can proceed to the step of scanning QR/barcode/RFID, as shown in the screen 191.

As shown in a screen 192, the worker terminal 3 may receive a receiving path from the cloud server 110. The VMS 111 may be equipped with path determination software that determines a recommended receiving path. The path determination software may determine the location of the rack where the item is to be received, the empty space within the empty rack, and the receiving path from the worker's location to the location of the rack where the item is to be received, based on the worker's location, the location of empty racks, and empty space within the empty racks. In addition, the path determination software may determine the location of the rack where the item is to be received, considering the type, importance, and shipping priority of the item. The path determination software may determine the receiving path based on at least one of the shortest time, shortest distance, or minimum complexity among a plurality of paths between the worker's location and the location of the rack where the determined item is to be received. On the worker terminal 3, a receiving path 1922 from the worker's location 1921 to the location of the rack C-4 where the item will be received may be displayed on a schematic map representing the logistics center, as shown in the screen 192. Although the screen 192 of FIG. 19 is based on a 2D map, a 3D map may be provided on the screen 192, and the receiving path may be displayed on the 3D map.

As shown in a screen 193, a location C4_L1_1 indicating an empty space where an item may be received in a rack C-4 may be displayed. In the screen 193, the location C4_L1_1 may be displayed with a guide message “receive here” along with “/”.

The worker may perform receiving location authentication using the worker terminal 3. For example, after receiving an item at a receiving location, the worker may scan the QR/barcode/RFID of the corresponding rack using the worker terminal 3. The QR/barcode/RFID information of the scanned rack by the worker terminal 3 is transmitted to the VMS 111, and the VMS 111 may determine whether there is a match between the instructed receiving location and the scanned receiving location. While determining the match, a receiving authentication screen may be displayed on the worker terminal 3, as shown in a screen 194. If the matching between the instructed receiving location and the scanned receiving location fails, the VMS 111 may determine that the receiving location authentication has failed and push-notify the receiving location authentication failure to the worker terminal 3 and the administrator terminal 2. If the matching between the instructed receiving location and the scanned receiving location is successful, the VMS 111 may determine that the receiving location authentication is successful. The VMS 111 may input special notes along with the receiving location authentication input into the database. The VMS 111 may transmit the receiving completion to the worker terminal 3. When the worker terminal 3 receives the receiving completion, it may display a screen 195.

As described above, the worker may check the receiving location on a map through the worker terminal 3 and perform receiving tasks along the optimal path from the current location. This may shorten the time required for receipt. Since items are received at the most optimal locations based on item type, importance, and shipping priority, inventory loading may be automatically optimized. Then, tasks such as inventory movement and confirmation may not be necessary.

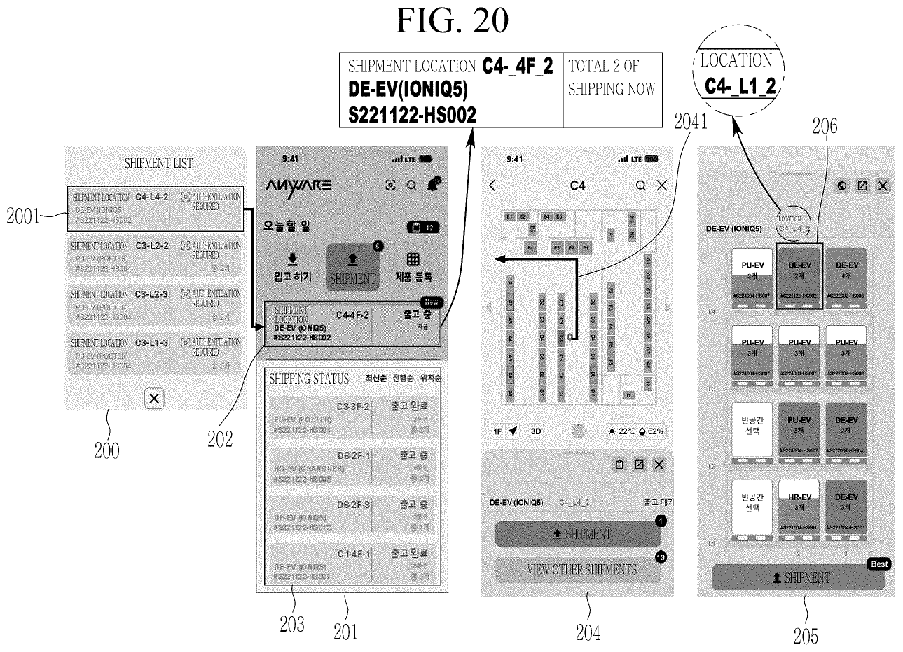

FIG. 20 is a drawing showing a shipping task progress screen provided on a work terminal.

The VMS 111 may generate scheduled shipping tasks based on a shipping order and assign the generated scheduled shipping tasks to each of a plurality of workers. The VMS 111 may generate a shipping list for the scheduled shipping tasks assigned to each of the plurality of workers. When generating the shipping list for each worker, the VMS 111 may determine the optimal shipping path. For example, the VMS 111 may determine picking priorities for each of the scheduled shipping tasks assigned to each worker based on factors determining the shipping sequence, generate a shipping list according to the determined picking priorities, and determine a picking path according to the shipping list. The factors determining the shipping sequence may include the weight of an item, the size of an item, the number of identical items, the distance between items, the handling caution level, first-in-first-out, expiration date, and the like. The heavier the item, the larger the item, the more identical items there are, the shorter the distance between items, the lower the handling caution level, and the earlier the time of receipt, the higher the picking priority. The handling caution level may be higher for items with a greater risk of breaking or damage. In addition, for items that are frequently received and shipped, that is, items that are frequently ordered and thus frequently received and shipped, the VMS 111 may manage the items to be received near both the receiving area and the shipping area of the logistics center. For example, the VMS 111 may manage to receive items that are frequently received and shipped according to first-in-first-out selection in a rack close to both the receiving and shipping areas. Then, when a worker ships items that are frequently received and shipped, the worker may pick multiple items to be shipped at a specific location. In this way, the VMS 111 may determine a picking path considering the efficiency of shipping tasks and generate a shipping list based on the determined picking path.

The VMS 111 may transmit a corresponding shipping list to each of the multiple worker' respective worker terminals. The worker may proceed with shipping tasks according to the arrangement sequence of the shipping tasks in the shipping list. The worker may select a shipping task in sequence from the shipping list.

A shipping list 200 may be displayed on the worker terminal 3. The worker may select one scheduled shipping task 2001 from the shipping list 200 and proceed with the shipping task. The selected scheduled shipping task 2001 may be displayed in an area 202 on a shipping screen 201, and a list of all scheduled shipping tasks in the logistics center may be displayed in a shipping status window 203. The area 202 may display the location of the item to be shipped (outbound location) ‘C4-4F-2’, item information ‘DE-EV(IONIQ5)’, and ‘S221122-HS002’. The worker may move to the shipping location displayed in the area 202 and may ship the item corresponding to the item information displayed in the area 202.

The selected shipping task may be transmitted to the VMS 111, and the VMS 111 may transmit the picking path determined when generating the shipping list to the worker terminal 3. The worker terminal 3 may receive a picking instruction and a picking path from the VMS 111. The worker may pick items from the picking instruction while moving along the picking path.

The worker terminal 3 may display a picking path 2041, received from the VMS 111, on a map as shown in a screen 204. In addition, the worker terminal 3 may indicate that the item to be shipped is located at L4_2 in the C4 rack, as shown in a screen 205. In the screen 205, the L4_2 area 206 in the C4 rack may be displayed in a different manner than other areas. After picking the item, the worker may scan the QR/barcode/RFID of the rack through the worker terminal 3. The QR/barcode/RFID information of the scanned rack by the worker terminal 3 is transmitted to the VMS 111, and the VMS 111 may determine whether there is a match between the shipping location and the scanned shipping location. If the matching between the shipping location and the scanned shipping location fails, the VMS 111 may determine that the shipping location authentication has failed and push-notify the shipping location authentication failure to the worker terminal 3 and the administrator terminal 2. If the matching between the shipping location and the scanned shipping location is successful, the VMS 111 may determine that the shipping location authentication is successful. The VMS 111 may input special notes along with the shipping location authentication input. In this way, the worker may identify the exact location by checking the shipping location on a map. Since the picking task is performed via an optimal path from the worker's current location, picking time may be reduced.

Through the screen provided by the worker terminal 3, not only receiving and shipping tasks but also inspection tasks, return tasks, and the like may be performed in a similar manner.

The worker may select an inspection task from an inspection task list provided on the worker terminal 3. The VMS 111 may provide a path for moving to an inspection location to the worker terminal 3. The worker may check the inspection location where the selected inspection task will be performed via the worker terminal 3 on a 2D or 3D screen. After completing the inspection, the worker may scan the rack QR/barcode/RFID of the corresponding inspection location via the worker terminal 3. The QR/barcode/RFID information of the scanned rack by the worker terminal 3 is transmitted to the VMS 111, and the VMS 111 may determine whether there is a match between the inspection location and the scanned inspection location. If the matching between the inspection location and the scanned inspection location fails, the VMS 111 may determine that the inspection location authentication has failed and send push notification of the inspection location authentication failure to the worker terminal 3 and the administrator terminal 2. If the matching between the inspection location and the scanned inspection location is successful, the VMS 111 may determine that the inspection location authentication is successful. The VMS 111 may input special notes along with the inspection location authentication input. In this way, since the inspection location is provided to the worker on a map, inspection may be completed quickly.

The worker may select a return task from a return list provided on the worker terminal 3. The worker uses the worker terminal 3 to scan the QR code/barcode/RFID (hereinafter, “return code”) of the item to be returned. The VMS 111 determines a location to store the returned item (hereinafter, “return location”) according to the scanned return code and transmits the return location to the worker terminal 3. The return location may be displayed on a 2D or 3D map via the worker terminal 3. After completing the return, the worker may scan the rack QR/barcode/RFID of the corresponding return location via the worker terminal 3. The QR/barcode/RFID information of the scanned rack by the worker terminal 3 is transmitted to the VMS 111, and the VMS 111 may determine whether there is a match between the return location and the scanned return location. If the matching between the return location and the scanned return location fails, the VMS 111 may determine that the return location authentication has failed and push-notify the return location authentication failure to the worker terminal 3 and the administrator terminal 2. If the matching between the return location and the scanned return location is successful, the VMS 111 may determine that the return location authentication is successful. The VMS 111 may input special notes along with the return location authentication input. In this way, convenient return management is possible through return location recommendation and path guidance.

The worker may select and proceed with item registration through the worker terminal 3 when item registration is required. Item information may be input and registration may be completed through the worker terminal 3. Completion of registration via the worker terminal 3 may be notified by push to the administrator terminal 2.

The worker may search for an item name, location, item number, management number, date, manufacturer, orderer, and the like, through the worker terminal 3.

The worker may be guided through a moving path in the form of XR (extended reality), AR (augmented reality), or MR (mixed reality) through the worker terminal 3. When a camera of the worker terminal 3 is activated, receiving, shipping, inspection, and return paths may be displayed in an AR manner on a screen of the worker terminal 3. QR/barcode/RFID scanning may be performed through the worker terminal 3, and when the scanned object is an item, item information may be displayed in a pop-up manner on the worker terminal 3. Through this, the worker may easily identify inventory locations, quickly perform receiving/shipping/inspection/return tasks, and immediately confirm item information.

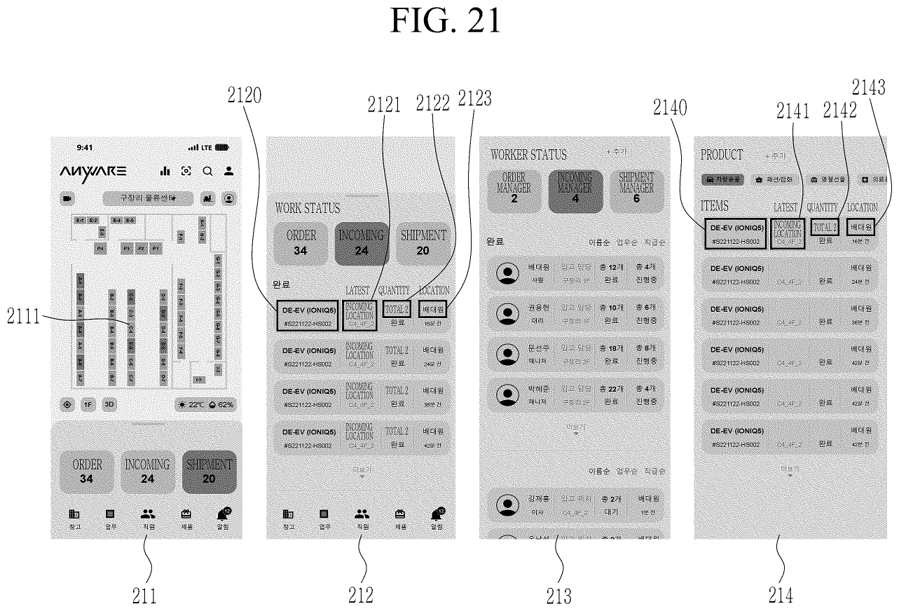

FIG. 21 is a drawing showing a status management screen provided on an administrator terminal.

On the administrator terminal 2 for the administrator, work status, worker status, item status, and the like may be displayed and utilized for management.

Through screens 211 and 212, the administrator may perform work status management. The status of orders, receiving, shipping, inspection, returns, packing, and item registration may be displayed on the screens 211 and 212. For example, the screen 211 may display the number of shipping tasks “20” and the location of racks 2111 being shipped. The screen 212 may display the number of completed receiving tasks “24”, each item 2120, receiving location 2121, quantity 2122, person in charge 2123, and the like.

Through a screen 213, the progress of workers' tasks may be displayed. For example, the screen 213 shows the work status of four receiving personnel. Through a screen 214, item status such as work records by category and by item may be displayed. For example, the screen 214 may display each item 2140, receiving location 2141, quantity 2142, person in charge 2143, and the like.

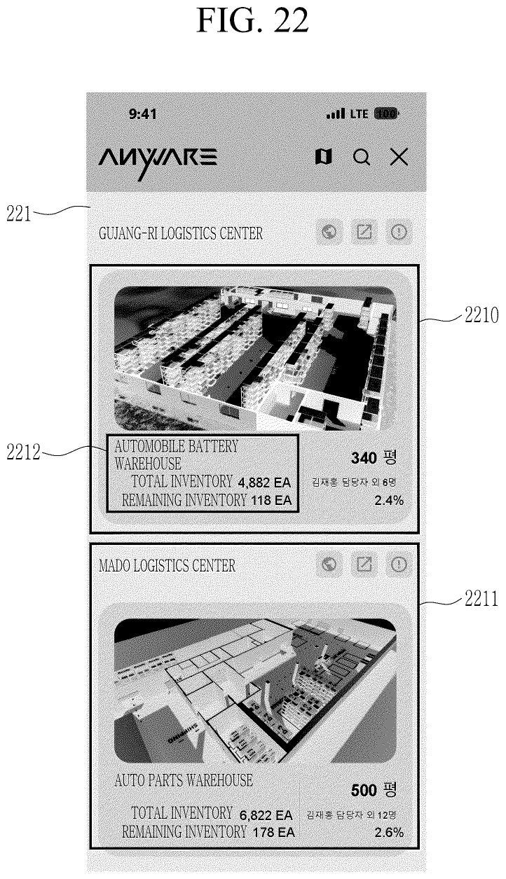

FIG. 22 is a drawing showing a warehouse management screen provided on an administrator terminal.

In a screen 221, a list window of multiple registered logistics centers may be opened. “Gujang-ri Logistics Center” 2210 and “Mado Logistics Center” 2211 are displayed on the screen 221. Inventory information 2212 for each logistics center is displayed, and a 3D screen of the corresponding logistics center may be accessed based on selection input on the screen 221.

The server 1 may detect an abnormal status by analyzing video obtained through the worker terminal 3 or various equipment within the logistics center. The cloud server 1 may detect abnormal situations within the logistics center, such as accidents between moving equipment, accidents between moving equipment and workers, damage to facilities located in the logistics center like racks, and fires, through video analysis. When the server 1 detects an abnormal status, it may send an abnormal status occurrence notification to the worker terminal 3 and the administrator terminal 2.

While the embodiment of the present disclosure has been described in connection with what are presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A 3D logistics integrated management system, comprising:
a server configured to store information necessary for logistics management within a logistics center in a database, and collect and provides information from the database;
an administrator terminal configured to display data provided from the server as a 3D screen via a plurality of interfaces; and
a worker terminal configured to display data provided from the server as a 3D screen via a worker application,
wherein the server collects and processes relevant data among the stored data in response to a request from the administrator terminal and/or the worker terminal, and transmits it to the administrator terminal and/or the worker terminal, and
the 3D screen of each of the administrator terminal and the worker terminal displays a 3D model implemented by 3D modeling the logistics center, and the 3D modeling for the logistics center is based on WebGL.

2. The 3D logistics integrated management system of claim 1, wherein
the plurality of interfaces include
an inventory management interface configured to provide functions of searching for items within the logistics center, inquiring about receiving/shipping and return/inspection status, and determining a work list.

3. The 3D logistics integrated management system of claim 2, wherein
the inventory management interface is configured to:
generate a query that requests information about an item to be searched, which is input via a search window, to the server, and display information corresponding to a response to the query received from the server, or
request, when a status inquiry is input, the status inquiry to the server and displays status information about items corresponding to the status inquiry provided from the server, and
display a work list and receives information for modification or confirmation of the work list.

4. The 3D logistics integrated management system of claim 1, wherein
the plurality of interfaces includes
a personnel management interface configured to provide an interface for managing personnel information related to attendance and work schedules of workers working in the logistics center.

5. The 3D logistics integrated management system of claim 1, wherein
the plurality of interfaces includes
an equipment management interface configured to provide an interface for managing equipment information related to transportation equipment, CCTV, automation equipment, and firefighting equipment located in the logistics center.

6. The 3D logistics integrated management system of claim 1, wherein
the plurality of interface includes
an asset management interface configured to provide an interface for managing asset information related to sales, profit and loss, and orders of the logistics center.

7. The 3D logistics integrated management system of claim 1, wherein
the plurality of interfaces includes
a center management interface configured to provide an interface for managing center information related to center registration and center relocation.

8. The 3D logistics integrated management system of claim 1, wherein
the plurality of interface includes
an asset management interface configured to provide an interface for managing asset information related to sales, profit and loss, and orders of the logistics center.

9. The 3D logistics integrated management system of claim 1, wherein
the server includes
a cloud server configured to collect and process information to be provided in response to a request from each of the plurality of interfaces from the database to provide it to a corresponding interface;
a cloud storage configured to store 3D modeling data regarding a 3D model modeling the logistics center in 3D and store a photo and a video of the logistics center; and
a WebGL engine configured to generate 3D modeling data for 3D modeling the interior of the logistics center and objects provided inside the logistics center as 3D models and upload them to the cloud storage.

10. The 3D logistics integrated management system of claim 1, wherein
the inventory management interface of the plurality of interfaces is configured to:
provide a search window on the 3D screen,
list up an item list for a search result of an item input in the search window; and
move the 3D screen to a box corresponding to a selected item in the item list.

11. (canceled)

12. The 3D logistics integrated management system of claim 1, wherein
the inventory management interface of the plurality of interfaces is configured to:
list up equipment in an equipment status window;
display a location of selected equipment on a 3D screen of the interior of the logistics center implemented in 3D; and
move the 3D screen to the location of the selected equipment.

13. The 3D logistics integrated management system of claim 1, wherein
the equipment management interface of the plurality of interfaces is configured to:
display a plurality of CCTVs installed in the logistics center on the 3D screen;
display a 3D image of an area covered by each of the plurality of CCTVs in a CCTV list window; and
provide a captured image of a CCTV selected in the CCTV list window.

14. The 3D logistics integrated management system of claim 1, wherein
the message management interface of the plurality of interfaces is configured to:
provide a message sending window for sending a message to a worker;
display messages sent to the worker in the message sending window in chronological order; and
provide a message history confirmation window in which messages transmitted and received between the administrator terminal and the worker terminal are arranged in chronological order.

15. The 3D logistics integrated management system of claim 1, wherein
the personnel management interface of the plurality of interfaces is configured to:
provide a task registration window registering a task and a task list window displaying a list of a registered task; and
transmit, when one of a plurality of tasks arranged in the task list window is selected and an assignment input is provided, information about the selected task to the server, and
the server push-notifies the selected task to a worker terminal corresponding to the selected task.

16. (canceled)

17. The 3D logistics integrated management system of claim 1, wherein
the asset management interface of the plurality of interfaces is configured to
provide at least one of number of orders by period, vacancy rate, number of items received, number of items shipped, number of items returned, sales statistics of logistics center, profit and loss of logistics center, and real-time statistics status of logistics center.

18. The 3D logistics integrated management system of claim 1, wherein
the center management interface of the plurality of interfaces is configured to
configure a logistics center status window based on information about a plurality of logistics centers to display it on the administrator terminal; and
display a 3D screen of a logistics center selected from the plurality of logistics centers via the logistics center status window on the administrator terminal.

19. The 3D logistics integrated management system of claim 1, wherein
the worker terminal is configured to:
generate and deletes a box in real time on a 3D rack in a 3D screen provided through the application based on receiving and shipping data,
add or delete 3D racks or 3D modeling data on the 3D screen based on changes in the arrangement of structures within the logistics center, and
arrange 3D assets in a 3D environment on the 3D screen and map data of the database corresponding to each of the arranged 3D assets.

20. The 3D logistics integrated management system of claim 1, wherein
the server is configured to:
determine a location and empty space of a rack for an item to be received, based on a location of a worker, a location of an empty rack, and an empty space of the empty rack; and
determine a receiving path from the location of the worker to the determined location of the rack, and
the worker terminal receives the receiving path from the server and displays the receiving path on a map indicating the logistics center.

21. The 3D logistics integrated management system of claim 1, wherein
the server is configured to:
generate scheduled shipping tasks based on a shipping order;
allocates the generated scheduled shipping tasks to each of a plurality of workers;
determine a picking priority for each of the scheduled shipping tasks allocated to respective workers based on factors determining a shipping order;
generate a shipping list according to the determined picking priority, and determines a picking path according to the shipping list; and
transmit a picking path for a scheduled shipping task selected from the shipping list by the worker terminal to the worker terminal.

22. The 3D logistics integrated management system of claim 1, wherein
the server
includes an IoT server that collects status information provided from an IoT device within the logistics center, and
is configured to provide information collected by the IoT server to the administrator terminal via one of the plurality of interfaces.
